(19) United States
(12) Patent Application Publication
(10) Pub. No.: US 2006/0130799 A1
(43) Pub. Date: Jun. 22, 2006

(54) Crankshaft bearing bridge for an internal combustion engine

(75) Inventors: Michael Paul, Weissach (DE); Joachim Gruenberger, Sachsenheim (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c.F. Porsche AG, Stuttgart (DE)

(21) Appl. No.: 11/313,755

(22) Filed: Dec. 22, 2005

(30) Foreign Application Priority Data
Dec. 22, 2004 (DE) 10 2004 061 672.8

(51) Int. Cl. F02F 7/00

(52) U.S. Cl. 123/195 H

(57) ABSTRACT

A crankshaft bearing bridge for a reciprocating piston internal combustion engine is connected to a cylinder crankcase at a parting plane and has external longitudinal side members running at a distance from a longitudinal axis of a crankshaft. Bearing crowns for the crankshaft run between the longitudinal side members across the longitudinal axis and are provided with bore halves of bearing bores for the crankshaft crank pins. In the direction of the crankshaft longitudinal axis, the bridge bearing crowns are supported with connecting elements extending between the longitudinal side members. The bearing crowns open into the longitudinal side members, at least in the area of the parting plane, and include widened areas.

### CROSS-REFERENCE TO RELATED APPLICATIONS

This application claims the priority of German Application No. 10 2004 061 672.8-13, filed Dec. 22, 2004, the disclosure of which is expressly incorporated by reference herein. This application is also related to U.S. application Ser. No. ______ (028987.56989US), filed in the name of Paul et al. concurrently herewith.

### BACKGROUND AND SUMMARY OF THE INVENTION

The present invention relates to a crankshaft bearing bridge for an internal combustion engine of the reciprocating piston type, the bridging being connected at a parting plane to a cylinder crankcase and having outer longitudinal side members running at a distance from a crankshaft longitudinal axis, comprising crankshaft bearing crowns aligned across the crankshaft longitudinal axis and extending between the longitudinal side members, the bearing crowns being provided with bore halves of bearing bores for crankshaft crank pins.

A known internal combustion engine of the general type identified in EP 0 038 560 A1 has a cylinder crankcase connected to a crankshaft bearing bridge at the parting plane. Between the cylinder crankcase and the crankshaft bearing bridge, a crankshaft bearing journal is accommodated by bores in bearing faces of the cylinder crankcase and the crankshaft bearing bridge running across the longitudinal axis of the crankcase. The bearing faces in the crankshaft bearing bridge are configured as bearing crowns in which bore halves of the bearing bores are recessed. The bearing crowns are bordered by longitudinal side members on the outer longitudinal sides of the crankshaft bearing bridge, with the longitudinal side members forming the only support for the bearing crown.

DE 34 26 208 C1 describes a crankshaft bearing for an internal combustion engine in which a crankcase and bearing crowns attached thereto, forming part of a crankshaft bearing bridge, are made of a lightweight metal alloy. The bearing crowns are configured as a cast sheathing for ferrometallic cores. Such cores contribute to increasing the stiffness of the bearing crowns and/or the crankshaft bearing bridge and also reduce the bearing play between the bearing bore and the bearing journal in the crankshaft, thereby causing noise.

DE 43 30 565 C1 describes a crankshaft bearing which is provided in a lightweight metal alloy housing of an internal combustion engine and includes a bearing bore for a crank pin. In this crankshaft bearing, a device acts to reduce the tendency of the bearing play between the bearing bore and the crank pin to increase. This device is configured as a ring-like compensator element that operates between the bearing bore and the crank pin and is made of a material having a relatively high thermal expansion coefficient.

An object of the present invention is to provide a crankshaft bearing bridge that is attached to a cylinder crankcase in a targeted manner with regard to strength and an unwanted increase in the size of the bore half of the bearing bore.

According to the present invention, this object has been achieved by providing that the bearing crowns are arranged to be supported in a direction of the crankshaft longitudinal axis via connecting elements extending between the longitudinal side members, and the bearing crowns open into the longitudinal side members at least in an area of the parting plane by way of widened areas.

Main advantages achieved with the present invention include, inter alia, the fact that owing to the particular structural configuration of the crankshaft bearing bridge made of a lightweight metal alloy, the bridge is advantageously and especially stiff, strong and has a low weight. The stiff frame joint with the joining elements between the thrust bearings of the crankshaft bearing bridge can be implemented with little effort without any additional devices such as ferrometallic insertion parts sheathed by casting that cause bimetal effects. The connecting elements and/or the relatively thin-walled parts forming them act not only as an oil plane but these connecting elements are also configured and arranged such that they result in relatively large oil passage channels so that pump losses are also reduced. In addition, this framework-like frame structure in combination with the thermally treated thrust bearings made of lightweight metal alloy contributes to the fact that there is a uniform, controlled increase in the bearing bore over the operating temperature of the internal combustion engine, i.e., the ovalization of said bearing bore is at least reduced.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic sectional view through an internal combustion engine having the crankshaft bearing bridge according to the present invention,

FIG. 2 is a sectional view along line II-II in FIG. 1 on a larger scale,

FIG. 3 is a sectional view along line III-III in FIG. 2,

FIG. 4 is a sectional view along IV-IV in FIG. 2,

FIG. 5 is a sectional along line V-V in FIG. 2, and

FIG. 6 is a schematic plan view shown, the crankshaft bearing bridge of FIG. 1, as seen from above.

### DETAILED DESCRIPTION OF THE DRAWINGS

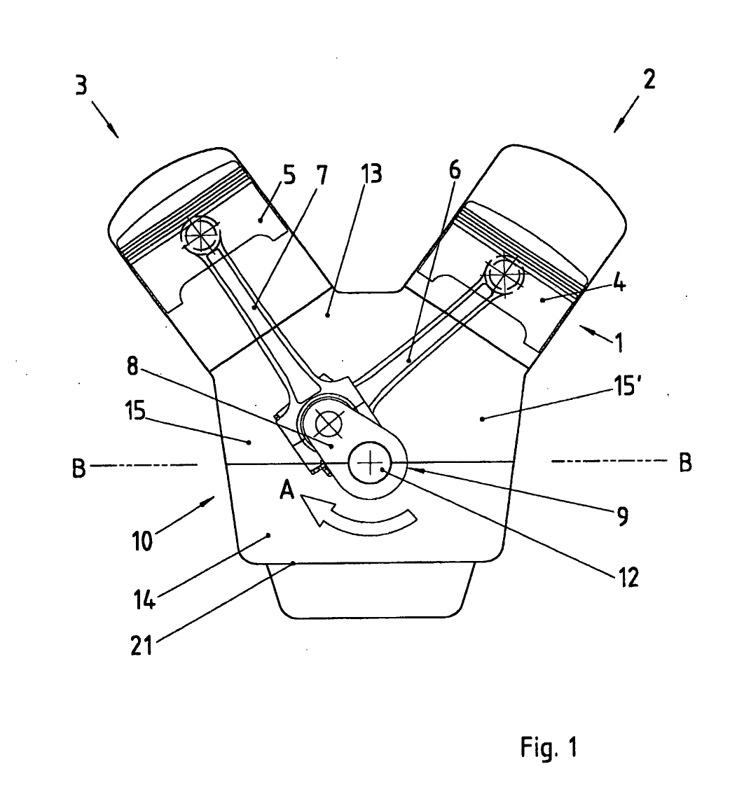

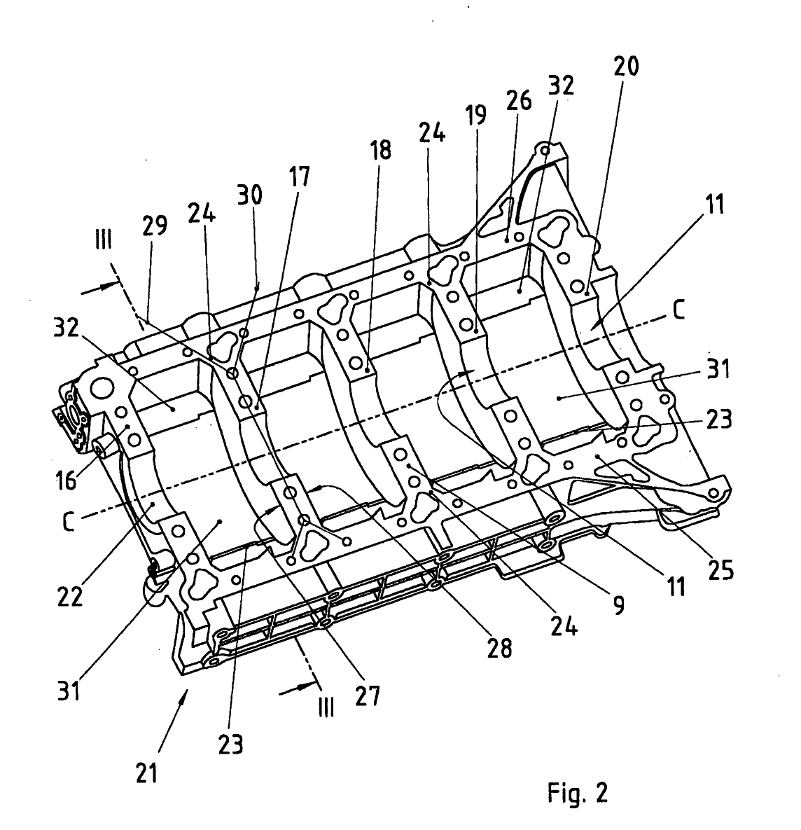

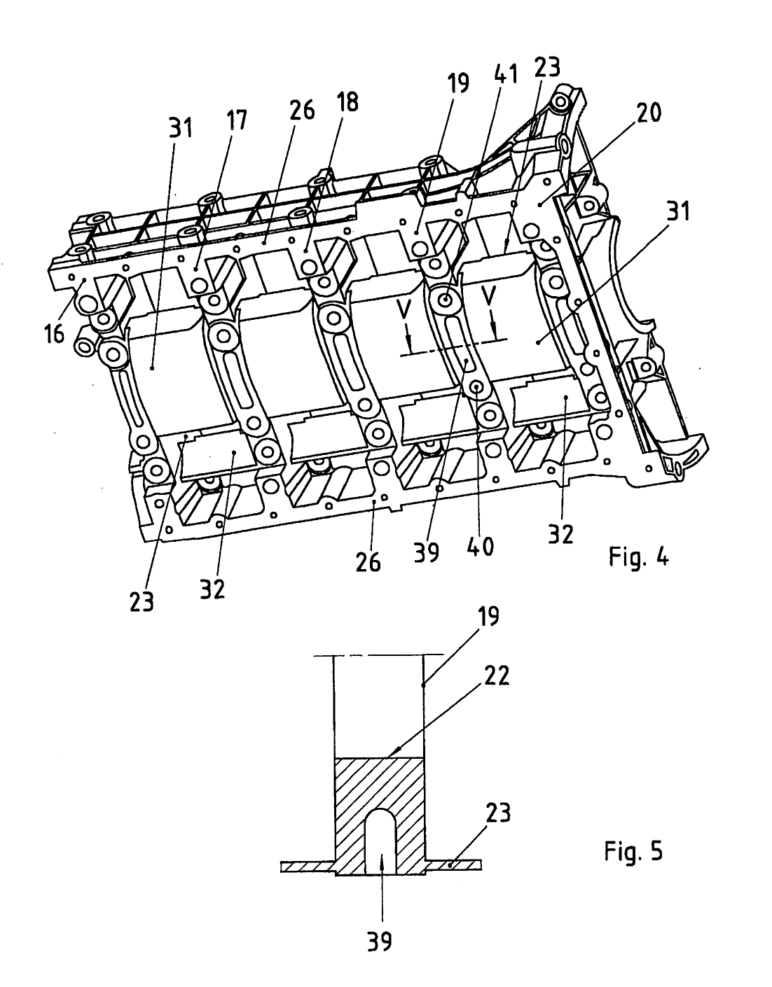

As shown in FIG. 1, an internal combustion engine 1 of the reciprocating piston type having multiple cylinders is configured for installation in a motor vehicle (not shown) and includes two cylinder rows 2, 3 arranged in the form of a V-shaped design having pistons 4, 5 working in the cylinders. The pistons 4 and 5 are connected by way of respective connecting rods 6, 7 to a crankshaft 8, which rotates in the direction of arrow A and is supported by crankshaft bearings 9. The crankshaft bearings 9 are formed by a cylinder crankcase 10 and a crankshaft bearing bridge 11, each consisting of a lightweight metal alloy and assembled in a parting plane B-B; together with bearing bores 12, they accommodate bearing journals (not shown) of the crankshaft 8 surrounding a longitudinal axis C-C (FIG. 2). To this end, the crankshaft bearing bridge 11 is provided with bearing crowns 13, 14, 15, 16 and 17 running across the longitudinal axis C-C, each having bore halves 18 (FIG. 5).

The bearing crowns 13, 14, 15, 16 and 17 are bordered by longitudinal side members 19, 20 on the outer longitudinal ends LI and LII and open into the longitudinal side members 19, 20 at least in the area of the parting plane B-B with the involvement of enlarged thickened-like areas 21. The widened areas 21 have a Y shape (as seen from above, looking onto the crankshaft bearing bridge in FIG. 2), tapering toward a parting plane D-D of the crankshaft bearing bridge 11 (FIG. 5) to which an oil pan Öw is connected. In the direction of the longitudinal axis C-C of the crankshaft 8, the bearing crowns are, as seen in FIG. 2, supported with connecting elements 22, 23, 24 and 25 which extend between the longitudinal side members 19, 20 and are manufactured in one piece with the bearing crowns 13, 14, 15, 16 and 17.

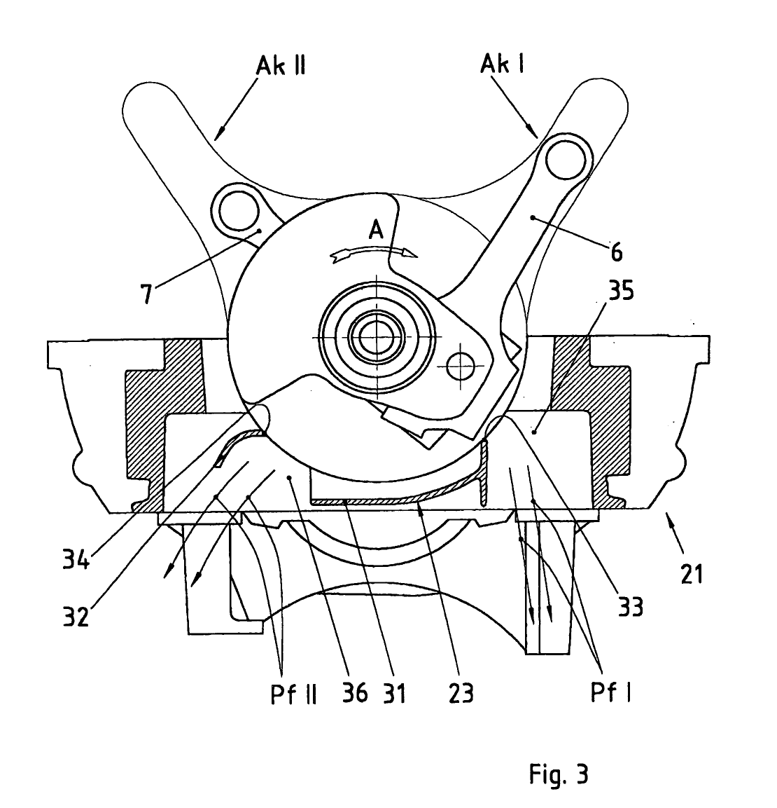

The connecting elements 22, 23, 24 and 25 extend over a significant width between the longitudinal side members 19, 20, whereby each connecting element, e.g., element 24 (FIG. 3) has a first element section 26 and a second element section 27 bordering a first oil passage channel 28. In addition, a second oil passage channel 29 and a third oil passage channel 30 are provided between the element sections 26, 27 and the longitudinal side members 19, 20. As seen in FIG. 3, the element sections 26,27 have relatively thin walls and are provided with profiled sections 31, 32 which increase the cross sectional strength. Thus, the first element section 26 is configured with a T-shaped cross section (horizontal T), namely such that one leg 33 runs approximately parallel to the parting plane B-B and a web 34 runs approximately at a right angle to the leg 33. The second element section 27, however, is configured to be almost C-shaped. Furthermore, free ends 35, 36 of the respective element sections, 26, 27 are configured as oil planes which are guided onto the stripping contours Ak of the connecting rods 6, 7.

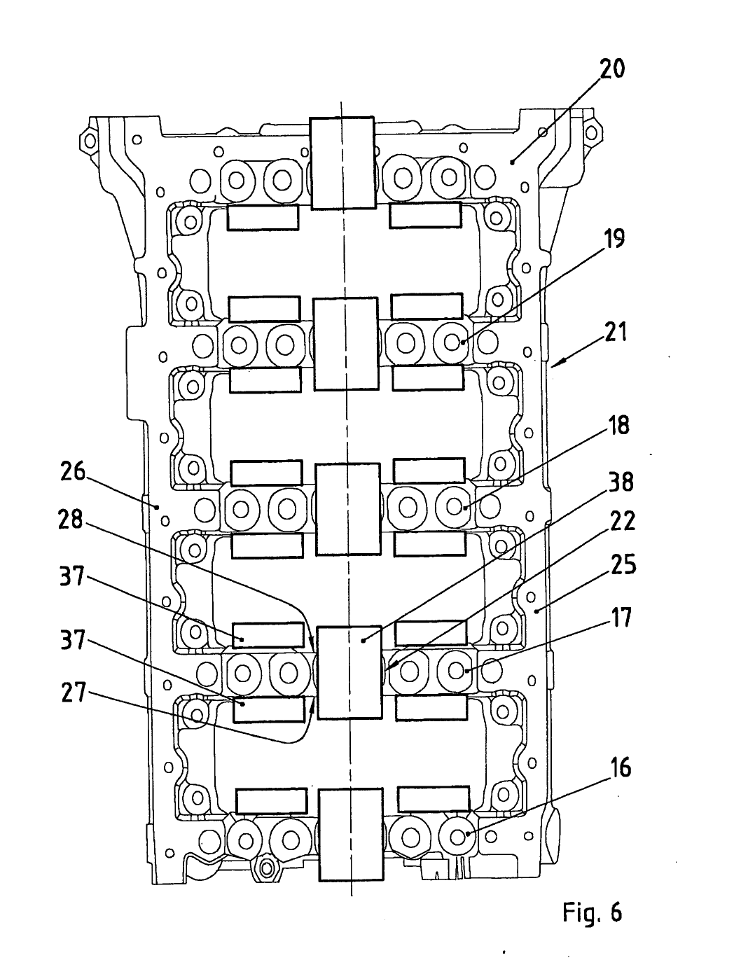

FIG. 6 shows how the strength properties of the bearing crowns 13,14,15,16,17 can be optimized by a targeted temperature treatment of same. These strength properties are influenced in a positive sense by controlled cooling (directed solidification of the lightweight metal melt) of the crankshaft bearing bridge 11 at the time of manufacture, namely by mounting first conventional cooling elements 37, and 38 on side walls 39, 40, respectively, and/or bore halves 18 of the bearing crowns 16,17,18,19,20, for example. The first and second cooling elements 37, 38 are each made of a ferrometallic material, where the first cooling elements 37 are plates that are attached to the side walls 39, 40 on both sides of the bearing crown, e.g., 16. The second cooling elements 38 are, however, configured as cylinders having a circular cross section and are provided with the shape of the bore halves 18 of the bearing crowns 13,14,15,16,17.

Relief recesses 41 are integrated into the bearing crowns 13 through 17 of the crankshaft bearing bridge 11 (FIGS. 4 and 5). These relief recesses are provided beneath the bore halves 18 in the bearing crowns and are introduced from the parting plane D-D. The relief devices 41 whose size can be determined empirically or by calculations, are configured with a U-shaped cross section and extend between through-bores 42, 43 which serve to receive fastening screws. The crankshaft bearing bridge 11 is held in position on the cylinder crankcase 10 of the internal combustion engine 1 with the fastening screws.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Crankshaft bearing bridge for a reciprocating engine, the bridge being connected at a parting plane to a cylinder crankcase and having outer longitudinal side members running at a distance from a crankshaft longitudinal axis, comprising crankshaft bearing crowns aligned across the crankshaft longitudinal axis and extending between the longitudinal side members, the bearing crowns being provided with bore halves of bearing bores for crankshaft crank pins, the bearing crowns are arranged to be supported in a direction of the crankshaft longitudinal axis via connecting elements extending between the longitudinal side members, and the bearing crowns open into a longitudinal side members at least in an area on the parting plane by way of widened areas.

2. Crankshaft bearing bridge as claimed in claim 1, wherein the connecting elements extend over a substantial width portion between the longitudinal side members.

3. Crankshaft bearing bridge as claimed in claim 1, wherein each of the connecting element has a first element section and a second element section, with at least one first oil passage channel being provided between the element sections.

4. Crankshaft bearing bridge as claimed in claim 3, wherein a second oil passage channel and a third oil passage channel are provided between the element sections and the adjacent longitudinal side members.

5. Crankshaft bearing bridge as claimed in claim 3, wherein the element sections have relatively thin walls, as viewed in cross section, and have strength-enhancing profiled sections.

6. Crankshaft bearing bridge as claimed in claim 5, wherein the first element section has a T-shaped cross section, with one leg thereof running approximately parallel to the parting plane and a web running at a right angle to the leg.

7. Crankshaft bearing bridge as claimed in claim 5, wherein the second element section has an approximately C-shaped cross section.

8. Crankshaft bearing bridge as claimed in claim 6, wherein free ends of the element sections are configured as oil planes for connecting rods moving between the bearing crowns.

9. Crankshaft bearing bridge as claimed in claim 7, wherein free ends of the element sections are configured oil planes for connecting rods moving between the bearing crowns.

10. Crankshaft bearing bridge as claimed in claim 1, wherein the bearing crowns are provided with optimized strength properties via targeted thermal treatment which includes heating and cooling.

11. Crankshaft bearing bridge as claimed in claim 10, wherein first and second cooling elements are provided in a targeted manner on said bearing crowns in the manufacture of the crankshaft bearing bridge to increase the strength properties.

12. Crankshaft bearing bridge as claimed in claim 11, wherein the first cooling elements are operatively arranged at side walls of the bearing crowns.

13. Crankshaft bearing bridge as claimed in claim 11, wherein the second cooling elements are operatively associated at both sides of the bore halves of the bearing crowns.

14. Crankshaft bearing bridge as claimed in claim 13, wherein the first cooling elements are operatively arranged at side walls of the bearing crowns.

15. Crankshaft bearing bridge as claimed in claim 1, wherein relief recesses are arranged at the bearing crowns.

16. Crankshaft bearing bridge as claimed in claim 15, wherein the relief recesses are arranged below the bore halves in the bearing crowns.

17. Crankshaft bearing bridge as claimed in claim 16, wherein the relief recesses have a U-shaped cross section.

18. Crankshaft bearing bridge as claimed in claim 15, wherein the relief recesses extend between through-bores for crankshaft bearing bridge fastening screw.

19. In a reciprocating piston engine, the improvement comprising a crankshaft bearing bridge being connected at a parting plane to a cylinder crankcase and having outer longitudinal side members running at a distance from a crankshaft longitudinal axis, crankshaft bearing crowns aligned across the crankshaft longitudinal axis and extending between the longitudinal side members, the bearing crowns being provided with bore halves of bearing bores for crankshaft crank pins, the bearing crowns are arranged to be supported in a direction of the crankshaft longitudinal axis via connecting elements extending between the longitudinal side members, and the bearing crowns opening into the longitudinal side members at least in an area of the parting plane by way of widened areas.
